(19) United States
(12) Patent Application Publication
(10) Pub. No.: US 2005/0131756 A1
(43) Pub. Date: Jun. 16, 2005

(54) Automated and variably weighted applicant and employee screening system

(76) Inventor: Sheila D. Benson, Sterrett, AL (US)

Correspondence Address: BRADLEY ARANT ROSE & WHITE LLP, 200 CLINTON AVE. WEST, SUITE 900, HUNTSVILLE, AL, 35801, US

(21) Appl. No.: 10/872,263

(22) Filed: Jun. 18, 2004

Related U.S. Application Data
(60) Provisional application No. 60/479,688, filed on Jun. 19, 2003.

(51) Int. Cl. G06F 17/60

(52) U.S. Cl. 705/11; 705/1

(57) ABSTRACT

An automated and variably weighted applicant and employee screening system has been developed. The system includes receiving a screening request that identifies an applicant for employment. Next, information about the applicant is requested from external information sources. The external information sources reply by sending data to the system concerning the applicant. The data is then graded according to a customized set of rules determined by a potential employer that evaluates the applicant for suitability for employment.

### CROSS-REFERENCE TO RELATED APPLICATIONS

This application claims priority from a U.S. Provisional Patent Application entitled “Automated and Variably Weighted Applicant and Employee Screening System” that was filed on Jun. 19, 2003.

### BACKGROUND OF INVENTION

1. Field of the Invention

The invention relates generally to a method for screening applicants for employment positions. More particularly, the invention relates to a method for variably weighting factors and automatically evaluating applicant characteristics.

2. Background Art

Evaluation of Applicants for new employee positions, or current employees for potential advancement requires the assessment of an increasing number of variables. Factors such as credit worthiness, employment history, and other items frequently requested on applicant/employee forms are typically considered on an ad hoc basis by potential employers. Employers in different levels of service and in different professions may assign different weights to certain criteria, such as poor credit worthiness being deeply disturbing in a banking-related position whereas it may make no difference in a manual labor environment. Accordingly, each industry, and even each employer, optimally may be able to consider factors on its own weighted scale. Increasingly, companies must verify information from conflicting sources and from increasing numbers of divergent sources.

The prior art method of handling these inquires is typically a hand review of information in a standardized pattern. An automated method of screening applicant's characteristics with variable weighting is needed.

### SUMMARY OF INVENTION

In some aspects, the invention relates to a method for screening an applicant for employment, comprising: receiving a screening request that identifies an applicant for employment; requesting information about the applicant from external information sources; receiving data concerning the applicant from the external information sources; and evaluating the applicant for suitability for employment based on grading the data received from the external information sources, where the data is graded according to a customized set of rules determined by a potential employer.

In other aspects, the invention relates to a method for screening an applicant for employment, comprising: step for requesting information about the applicant for employment from external information sources; step for receiving data concerning the applicant from the external information sources; and step for evaluating the applicant for suitability for employment based on grading the data received from the external information sources, where the data is graded according to a customized set of rules determined by a potential employer.

Advantages of the present invention include allowing fast, easy, and accurate automated screening of applicants for employment. Other advantages include minimizing human judgment from the applicant screening process in order to reduce the risk of bias and discrimination. Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a block diagram of one embodiment of the present invention.

FIG. 2 shows a flow chart of one embodiment of the present invention.

FIG. 3a shows an embodiment of a grading scale form for the present invention.

FIG. 3b shows an embodiment of a customized grading scale for the present invention.

FIG. 4 shows an example data entry screen for one embodiment of the present invention.

FIG. 5 shows an example of a form rejection letter that may be generated for one embodiment of the present invention.

### DETAILED DESCRIPTION

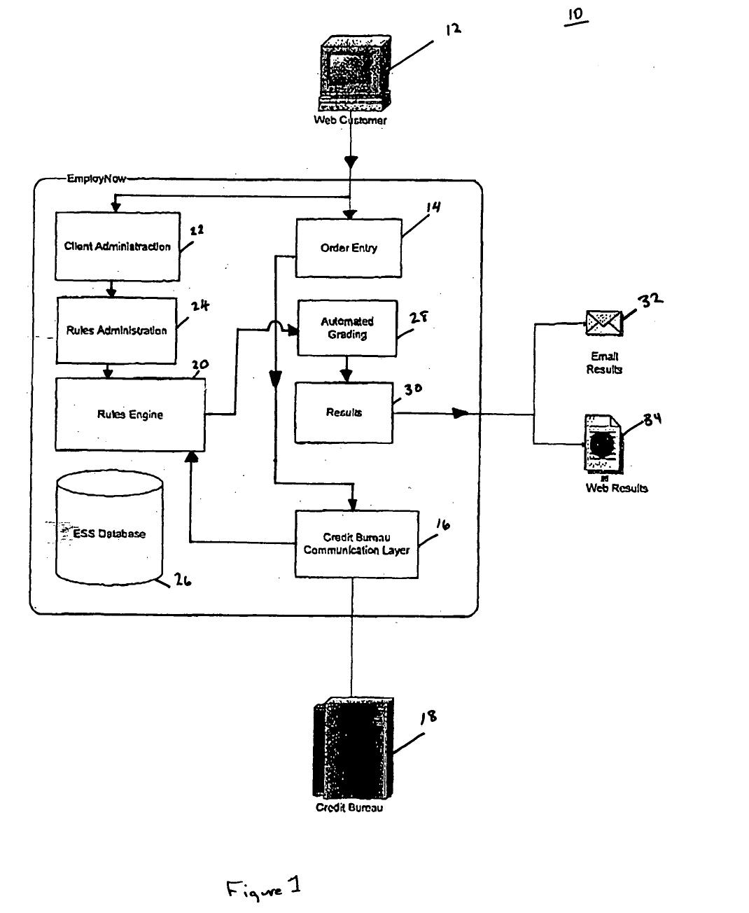

An automated screening system of employment applicants with variable weighting has been developed. FIG. 1 shows a block diagram 10 of one embodiment of the present invention. The system allows an external customer 12 to order a screening 14 of a prospective employee that is generated automatically. The customer 14 may also adjust their user information 22 and adjust or “weight” a series of rules 24 for evaluating or “grading” the applicant. The order entry 14 contains specified information about the applicant that is transmitted through an interface 16 to an external database such as a credit bureau 18. The credit bureau 18 returns information concerning the applicant to the system back through the interface 16 and on to the rules engine 20. The rules engine 20 takes the information and the rules and automatically “grades” the applicant 28. The results 30 of the grading are presented to the user. The results may be in the form of an email message 32 or posted on a website 34. An additional feature of the system is the database 26 which is used to store information such as: the client administrative data; the weighted rules; the applicant's data contained in the order; the data received from the external database; the grade results for an applicant; and any other information that may be necessary to operate the system.

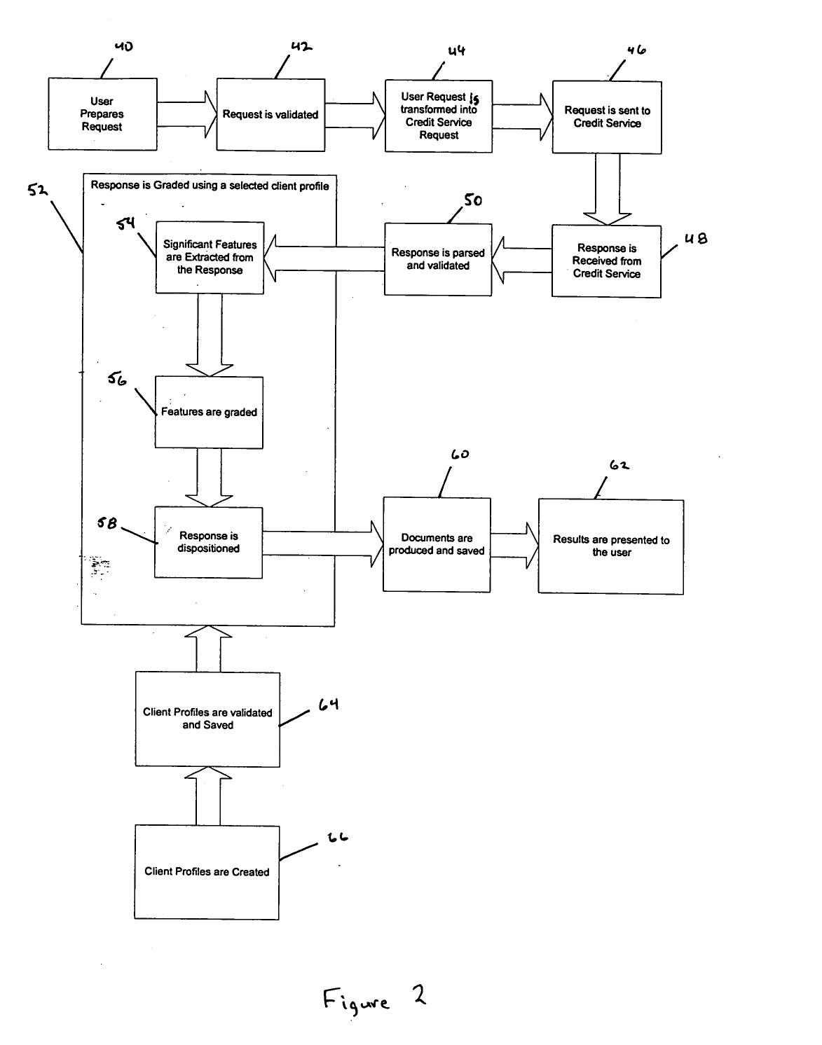

FIG. 2 provides a more detailed flow chart that describes the steps of the system. First, the user prepares a request 40 that is validated 42 to ensure that all necessary information is present. Next, the user's request is transformed to a credit service request 44 and sent to the credit service 46. When the request is received by the credit service 48, it is parsed and validated 50 and the pertinent data is returned to the system 52 for grading according the weighted rules set by the user. An appropriate response for the applicant is created 58 based on these results. Relevant documents such as a rejection notification for unsuitable applicants, are generated 60 and presented to the user 62. Also, the client/user may create and update their profile 66. The profile is then validated to ensure all necessary information is present and saved 64 by the system.

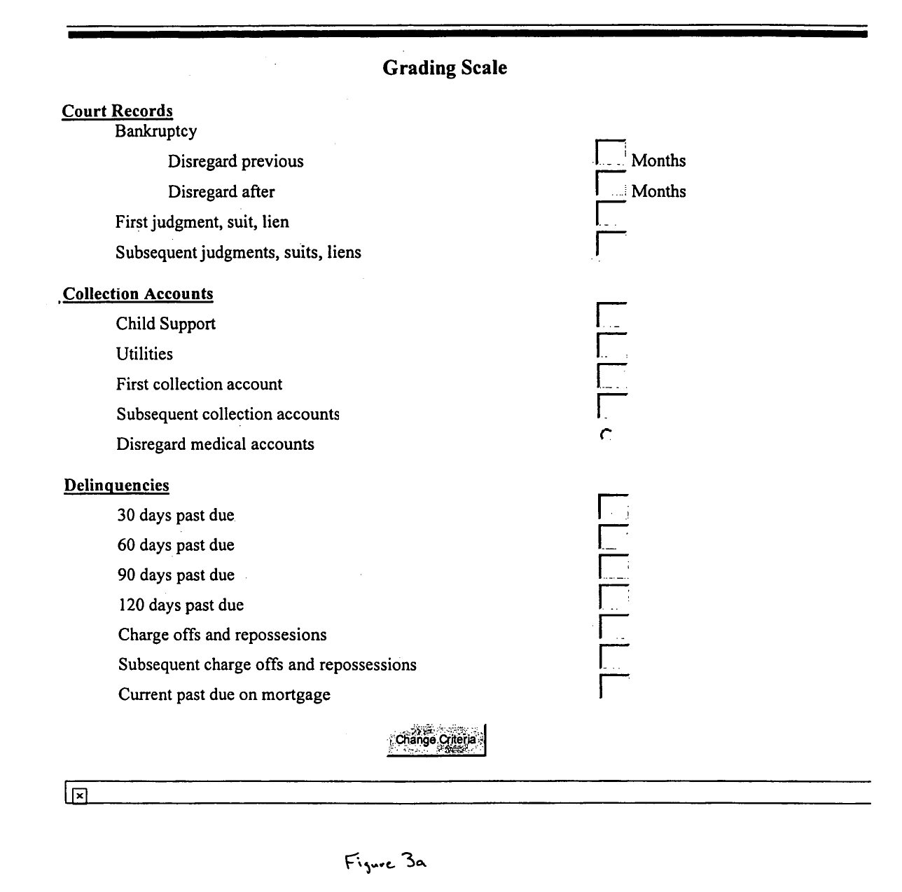

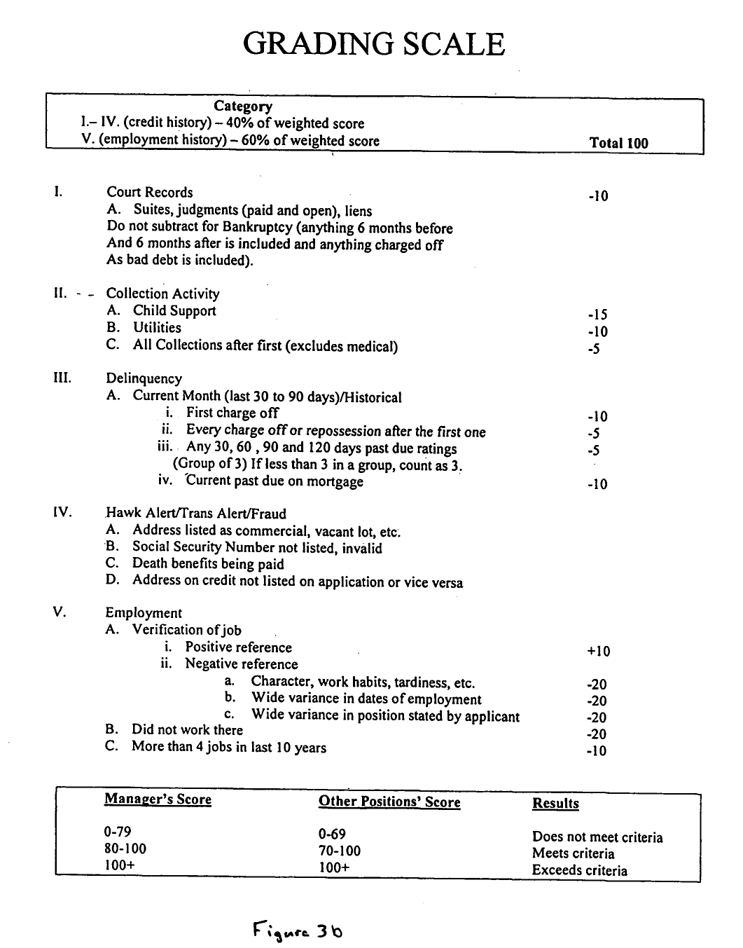

One important advantage of the present invention is the ability to allow the customer/user to adjust the weighting of the characteristics used to evaluate the applicant. These individual weighting schemes are called “grading scales”. The grading scales are created and stored for each customer/user based on their preferences. Multiple grading scales may be stored for a single customer/user for different employment positions such as hourly, salaried, clerical, accounting, etc. FIG. 3a shows an example of a blank grading scale form for the present invention. Examples of categories of characteristics that may be weighted include:
(1) income reports;
(2) bankruptcies;
(3) lien reports;
(4) lawsuits;
(5) criminal records;
(6) judgments;
(7) utility collection;
(8) medical collection;
(9) child support activity;
(10) delinquency of accounts;
(11) repossessions;
(12) charge offs of accounts;
(13) average loan balances;
(14) physical address assessment (e.g., whether the listed address is categorized as vacant, commercial, invalid, etc.);
(15) social security number;
(16) death benefits; and
(17) job references.
   Also, the customer/user may adjust the time parameters for consideration of the characteristics. As shown in FIG. 3a, the customer/user may instruct the system to ignore a bankruptcy after a certain number of months. The customer user may instruct the system to ignore other characteristics such as medical collections. While the examples given are typical information provided by a credit reporting entity, it should be understood that other sources of information such as: civil court records; criminal court records; databases collecting termination events; driver's records; law enforcement records; prison records; social security reports; mortgage reports; and any other available sources of information.

FIG. 3b shows an example of a customized grading scale for the present invention. In this Figure, the customer/user has adjusted the grading scale so that the applicant's credit history will provide 40% of the weighted score and the applicant's employment history will provide 60% of the weighted score. The information received on the applicant is placed into one of these historical categories and a tally for all events is calculated. The tallies for each historical category is assigned the proper weight and added together to reach a weighted numerical score for the applicant.

In this example, the applicant has a total of 100 points. Certain events such as a collection for utilities (−10 points), will impact negatively on the applicant's point total. Other events such as verification of a previous job (+10 points), will impact positively on the point total. Other events such as a positive reference (0 points) may have no impact on scoring at all. Also, negative values may be assigned to events that reflect no information where information is typically found for the majority of applicants. Each of the values of these events may be adjusted by the customer/user.

The grading scale may also establish a scoring range for determining the qualifications of the applicant. In this example, there are two categories of employees (“Managers” and “Other Positions”) and each has an established range for an applicant who meets, exceeds, or fails to meet the hiring criteria. In other embodiments, multiple applicants could simply be ranked according to their numerical score without classification for meeting specified criteria.

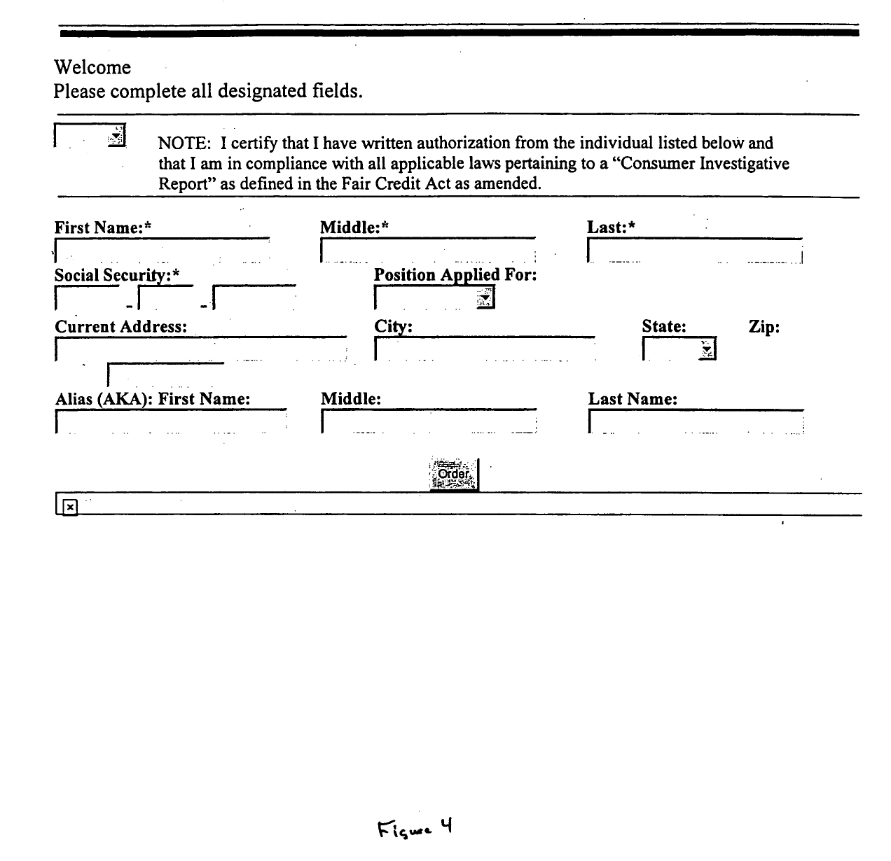

After a grading scale is established in the system, a user may initiate a screening request for an applicant. First, the user accesses the system through the internet, although other computer or automated networks may be used. The user logs on and authenticates the user against an application database such as an SQL server. After the user is authenticated, a data entry screen is presented. FIG. 4 shows an example data entry screen. The user then enters information about the applicant such as name, address, social security number, any aliases, and the position applied for. The data entry screen may be configured to require certain information while other information may be optional. Additionally, legal notices and certifications by user may be presented at this point.

Next, the request is forwarded to an outside information source such as a credit reporting service. Communications between the system and any outside entities are secured to prevent unauthorized access. Examples of such security measures include the use of a SSL (secure socket layer) and signed certificates to make sure data is properly encrypted. Once a response from the outside source is received, it is checked for validity to ensure the data reported applies to the applicant. The response is parsed to create a structured version of the data that is readable by the system. The data is then inspected to determine if any events correspond to the events in the grading scale. The corresponding events are assigned points according to the grading scale and weighted appropriately.

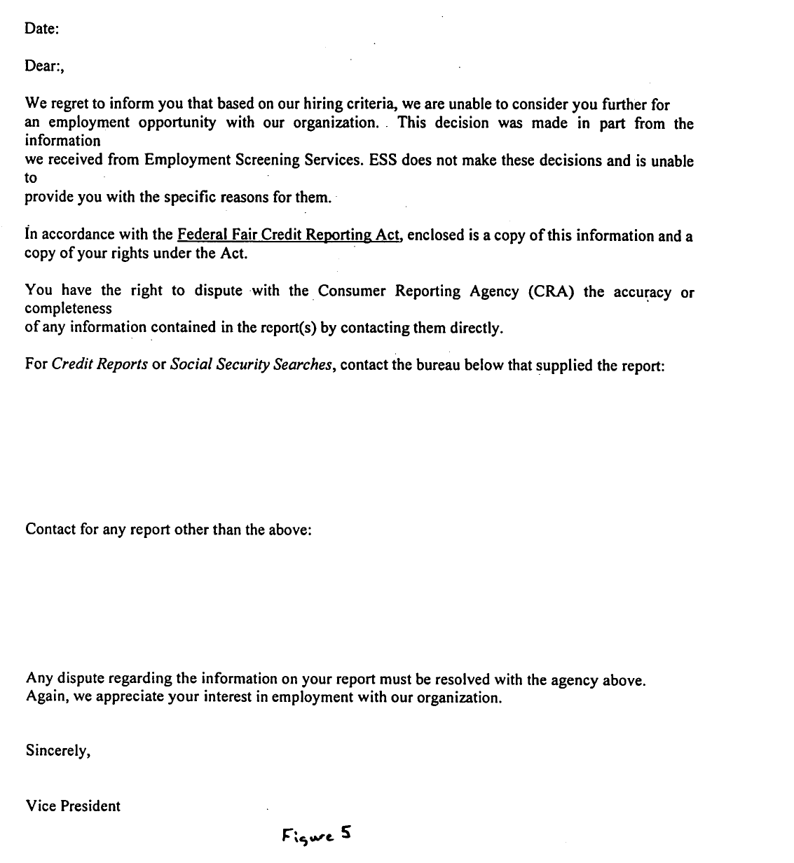

After the request is scored by the system, a disposition of the applicant is determined according to the instructions from the user. The appropriate response may be in the form a letter or an email. These may be sent to the applicant, the user, or some other interested party as designated by the user. If the desired response is in the form of a document, several types of documents may be generated, including: grading reports; credit reports; adverse action letters; raw request; raw response; structured response; and a log of grading activity. FIG. 5 shows an example of an adverse action letter. Additionally, the documents may be presented in a format that is easily printed and saved but difficult to change or edit by the user. This helps prevent accidentally changing the results.

Typically, all of the generated documents and other data received, processed, and produced by the system is stored for later retrieval if necessary. It should be understood, that the present invention is intended to be used on automated computer networks such as the internet. However, other types of computerized systems could be used to receive, process and store the data according to various embodiments of the inventions as disclosed.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

1. A method for screening an applicant for employment, comprising:
receiving a screening request that identifies an applicant for employment;
requesting information about the applicant from external information sources;
receiving data concerning the applicant from the external information sources; and
evaluating the applicant for suitability for employment based on grading the data received from the external information sources, where the data is graded according to a customized set of rules determined by a potential employer.

2. The method of claim 1, further comprising:
generating a response according to the suitability of the applicant for employment.

3. The method of claim 1, where the external information source is a credit reporting service.

4. The method of claim 1, where the data concerning the applicant is a credit report.

5. The method of claim 1, where the customized set of rules penalize the applicant for negative data as designated by the potential employer.

6. The method of claim 1, where the customized set of rules rewards the applicant for positive data as designated by the potential employer.

7. The method of claim 1, where the customized set of rules does not penalize or reward the applicant for neutral data as designated by the potential employer.

8. The method of claim 2, where the response is an email.

9. The method of claim 2, where the response is a letter.

10. A method for screening an applicant for employment, comprising:
step for requesting information about the applicant for employment from external information sources;
step for receiving data concerning the applicant from the external information sources; and
step for evaluating the applicant for suitability for employment based on grading the data received from the external information sources, where the data is graded according to a customized set of rules determined by a potential employer.

11. The method of claim 10, further comprising:
step for generating a response according to the suitability of the applicant for employment.
